(19) United States
(12) Patent Application Publication
(10) Pub. No.: US 2024/0306732 A1
(43) Pub. Date: Sep. 19, 2024

(54) AEROSOL-GENERATING DEVICE AND OPERATION METHOD THEREOF

(71) Applicant: KT&G CORPORATION, Daejeon (KR)

(72) Inventors: Daenam HAN, Seoul (KR); Seoksu JANG, Seoul (KR); Seungwon LEE, Gwangmyung-si Gyeonggi-do (KR); Sungwook YOON, Suwon-si Gyeonggi-do (KR); Yonghwan KIM, Anyang-si Gyeonggi-do (KR)

(73) Assignee: KT&G CORPORATION, Daejeon (KR)

(21) Appl. No.: 18/280,185

(22) PCT Filed: Dec. 14, 2021
(86) PCT No.: PCT/KR2021/018939

§ 371 Date: Sep. 1, 2023

(30) Foreign Application Priority Data
Dec. 23, 2020 (KR) 10-2020-0182390

(51) Int. Cl. A24F 40/90; A24F 40/50; H01M 10/44; H02J 7/00

(52) U.S. Cl. CPC A24F 40/90; A24F 40/50; H01M 10/446; H01M 10/448; H02J 7/0063; H02J 7/007182; H01M 2220/30

(57) ABSTRACT

An aerosol-generating device and an operation method thereof are disclosed. The aerosol-generating device of the present disclosure includes a heater configured to heat an aerosol-generating substance, a battery configured to supply electric power to the heater, and a controller. The controller updates the number of times of charging/discharging of the battery based on at least one of a result of performing operation related to charging or a result of performing operation related to discharging. When the number of times of charging/discharging is less than a preset reference number of times, the controller maintains a reference voltage preset in relation to charging of the battery. When the number of times of charging/discharging is equal to or greater than the preset reference number of times, the controller changes the reference voltage to a second voltage level, which is lower than the currently set first voltage level.

### TECHNICAL FIELD

The present disclosure relates to an aerosol-generating device and an operation method thereof.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems. It is another object of the present disclosure to provide an aerosol-generating device and an operation method thereof capable of preventing the occurrence of swelling of a battery attributable to deterioration thereof.

### Technical Solution

An aerosol-generating device according to various embodiments of the present disclosure for accomplishing the above and other objects may include a heater configured to heat an aerosol-generating substance, a battery configured to supply electric power to the heater, and a controller. The controller may update the number of times of charging/discharging of the battery based on at least one of a result of performing operation related to charging or a result of performing operation related to discharging. When the number of times of charging/discharging is less than a preset reference number of times, the controller may maintain a reference voltage preset in relation to charging of the battery. When the number of times of charging/discharging is equal to or greater than the preset reference number of times, the controller may change the reference voltage to a second voltage level, which is lower than the currently set first voltage level.

An operation method of an aerosol-generating device according to various embodiments of the present disclosure for accomplishing the above and other objects may include updating the number of times of charging/discharging of a battery of the aerosol-generating device based on at least one of a result of performing operation related to charging or a result of performing operation related to discharging, maintaining, when the number of times of charging/discharging is less than a preset reference number of times, a reference voltage preset in relation to charging of the battery, and changing, when the number of times of charging/discharging is equal to or greater than the preset reference number of times, the reference voltage to a second voltage level, which is lower than the currently set first voltage level.

### Advantageous Effects of Invention

According to at least one of embodiments of the present disclosure, a reference voltage used when charging a battery is reset based on the cycle count of the battery according to charging and/or discharging of the battery, thus making it possible to prevent the occurrence of swelling of the battery attributable to deterioration or overcharging thereof.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure:

FIGS. 2A to 4 are views for explaining an aerosol-generating device according to embodiments of the present disclosure:

FIGS. 5 to 6B are flowcharts showing an operation method of the aerosol-generating device according to an embodiment of the present disclosure; and

FIGS. 7A to 9 are views for explaining the operation of the aerosol-generating device.

### BEST MODE FOR CARRYING OUT THE INVENTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

FIG. 1 is a block diagram of an aerosol-generating device according to an embodiment of the present disclosure.

Referring to FIG. 1, an aerosol-generating device 100 may include a communication interface 110, an input/output interface 120, an aerosol-generating module 130, a memory 140, a sensor module 150, a battery 160, and/or a controller 170.

In one embodiment, the aerosol-generating device 100 may be composed only of a main body. In this case, components included in the aerosol-generating device 100 may be located in the main body. In another embodiment, the aerosol-generating device 100 may be composed of a cartridge, which contains an aerosol-generating substance, and a main body. In this case, the components included in the aerosol-generating device 100 may be located in at least one of the main body or the cartridge.

The communication interface 110 may include at least one communication module for communication with an external device and/or a network. For example, the communication interface 110 may include a communication module for wired communication, such as a Universal Serial Bus (USB). For example, the communication interface 110 may include a communication module for wireless communication, such as Wireless Fidelity (Wi-Fi), Bluetooth, Bluetooth Low Energy (BLE), ZigBee, or nearfield communication (NFC).

The input/output interface 120 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 120 may transmit data corresponding to a command input by the user through the input device to another component (or other components) of the aerosol-generating device 100. The input/output interface 120 may output information corresponding to data received from another component (or other components) of the aerosol-generating device 100 through the output device.

The aerosol-generating module 130 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 130 may include at least one heater (not shown).

The aerosol-generating module 130 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 130 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 130 may generate ultrasonic vibrations to thereby generate an aerosol from the aerosol-generating substance.

The aerosol-generating device 100 may be referred to as a cartomizer, an atomizer, or a vaporizer.

The memory 140 may store programs for processing and controlling each signal in the controller 170, and may store processed data and data to be processed.

For example, the memory 140 may store applications designed for the purpose of performing various tasks that can be processed by the controller 170. The memory 140 may selectively provide some of the stored applications in response to the request from the controller 170.

For example, the memory 140 may store data on the operation time of the aerosol-generating device 100, the maximum number of puffs, the current number of puffs, the number of uses of battery 160, at least one temperature profile, at least one electric power profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 140 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 150 may include at least one sensor.

For example, the sensor module 150 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 150 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 150 may include a sensor for sensing the temperature of the heater included in the aerosol-generating module 130 and the temperature of the aerosol-generating substance (hereinafter referred to as a “temperature sensor”). In this case, the heater included in the aerosol-generating module 130 may also serve as the temperature sensor. For example, the electro-resistive material of the heater may be a material having a predetermined temperature coefficient of resistance. The sensor module 150 may measure the resistance of the heater, which varies according to the temperature, to thereby sense the temperature of the heater.

For example, in the case in which the main body of the aerosol-generating device 100 is formed to allow a cigarette to be inserted thereinto, the sensor module 150 may include a sensor for sensing insertion of the cigarette (hereinafter referred to as a “cigarette detection sensor”).

For example, in the case in which the aerosol-generating device 100 includes a cartridge, the sensor module 150 may include a sensor for sensing mounting/demounting of the cartridge and the position of the cartridge (hereinafter referred to as a “cartridge detection sensor”).

In this case, the cigarette detection sensor and/or the cartridge detection sensor may be implemented as an inductance-based sensor, a capacitive sensor, a resistance sensor, or a Hall sensor (or Hall IC) using a Hall effect.

For example, the sensor module 150 may include a voltage sensor for sensing a voltage applied to a component (e.g. the battery 160) provided in the aerosol-generating device 100 and/or a current sensor for sensing a current.

The battery 160 may supply electric power used for the operation of the aerosol-generating device 100 under the control of the controller 170. The battery 160 may supply electric power to other components provided in the aerosol-generating device 100. For example, the battery 160 may supply electric power to the communication module included in the communication interface 110, the output device included in the input/output interface 120, and the heater included in the aerosol-generating module 130.

The battery 160 may be a rechargeable battery or a disposable battery. For example, the battery 160 may be a lithium-ion (Li-ion) battery or a lithium polymer (Li-polymer) battery. However, the present disclosure is not limited thereto. For example, when the battery 160 is rechargeable, the charging rate (C-rate) of the battery 160 may be 10 C, and the discharging rate (C-rate) thereof may be 10 C to 20 C. However, the present disclosure is not limited thereto. Also, for stable use, the battery 160 may be manufactured such that 80% or more of the total capacity may be ensured even when charging/discharging is performed 2000 times.

The aerosol-generating device 100 may further include a battery protection circuit module (PCM) (not shown), which is a circuit for protecting the battery 160. The battery protection circuit module (PCM) may be disposed adjacent to the upper surface of the battery 160. For example, in order to prevent overcharging and overdischarging of the battery 160, the battery protection circuit module (PCM) may cut off the electrical path to the battery 160 when a short circuit occurs in a circuit connected to the battery 160, when an overvoltage is applied to the battery 160, or when an overcurrent flows through the battery 160.

The aerosol-generating device 100 may further include a charging terminal to which electric power supplied from the outside is input. For example, the charging terminal may be formed at one side of the main body of the aerosol-generating device 100. The aerosol-generating device 100 may charge the battery 160 using electric power supplied through the charging terminal. In this case, the charging terminal may be configured as a wired terminal for USB communication, a pogo pin, or the like.

The aerosol-generating device 100 may further include a power terminal (not shown) to which electric power supplied from the outside is input. For example, a power line may be connected to the power terminal, which is disposed at one side of the main body of the aerosol-generating device 100. The aerosol-generating device 100 may use the electric power supplied through the power line connected to the power terminal to charge the battery 160. In this case, the power terminal may be a wired terminal for USB communication.

The aerosol-generating device 100 may wirelessly receive electric power supplied from the outside through the communication interface 110. For example, the aerosol-generating device 100 may wirelessly receive electric power using an antenna included in the communication module for wireless communication. The aerosol-generating device 100 may charge the battery 160 using the wirelessly supplied electric power.

The controller 170 may control the overall operation of the aerosol-generating device 100. The controller 170 may be connected to each of the components provided in the aerosol-generating device 100. The controller 170 may transmit and/or receive a signal to and/or from each of the components, thereby controlling the overall operation of each of the components.

The controller 170 may include at least one processor. The controller 170 may control the overall operation of the aerosol-generating device 100 using the processor included therein. Here, the processor may be a general processor such as a central processing unit (CPU). Of course, the processor may be a dedicated device such as an application-specific integrated circuit (ASIC), or may be any of other hardware-based processors.

The controller 170 may perform any one of a plurality of functions of the aerosol-generating device 100. For example, the controller 170 may perform any one of a plurality of functions of the aerosol-generating device 100 (e.g. a preheating function, a heating function, a charging function, and a cleaning function) according to the state of each of the components provided in the aerosol-generating device 100 and the user's command received through the input/output interface 120.

The controller 170 may control the operation of each of the components provided in the aerosol-generating device 100 based on data stored in the memory 140. For example, the controller 170 may control the supply of a predetermined amount of electric power from the battery 160 to the aerosol-generating module 130 for a predetermined time based on the data on the temperature profile, the electric power profile, and the user's inhalation pattern, which is stored in the memory 140.

The controller 170 may determine the occurrence or non-occurrence of a puff using the puff sensor included in the sensor module 150. For example, the controller 170 may check a temperature change, a flow change, a pressure change, and a voltage change in the aerosol-generating device 100 based on the values sensed by the puff sensor. The controller 170 may determine the occurrence or non-occurrence of a puff based on the value sensed by the puff sensor.

The controller 170 may control the operation of each of the components provided in the aerosol-generating device 100 according to the occurrence or non-occurrence of a puff and/or the number of puffs. For example, upon determining that a puff has occurred, the controller 170 may perform control such that electric power is supplied to the heater according to the electric power profile stored in the memory 140. For example, the controller 170 may perform control such that the temperature of the heater is changed or maintained based on the temperature profile stored in the memory 140.

The controller 170 may perform control such that the supply of electric power to the heater is interrupted according to a predetermined condition. For example, the controller 170 may perform control such that the supply of electric power to the heater is interrupted when the cigarette is removed, when the cartridge is demounted, when the number of puffs reaches the predetermined maximum number of puffs, when a puff is not sensed during a predetermined period of time or longer, or when the remaining capacity of the battery 160 is less than a predetermined value.

The controller 170 may calculate the remaining capacity with respect to the full charge capacity of the battery 160. For example, the controller 170 may calculate the remaining capacity of the battery 160 based on the values sensed by the voltage sensor and/or the current sensor included in the sensor module 150.

The controller 170 may determine the degree of deterioration of the battery 160. For example, the controller 170 may calculate the cycle count of the battery 160 according to charging/discharging. The controller 170 may determine the degree of deterioration of the battery 160 based on the cycle count of the battery 160. Here, the cycle count of the battery 160 may be the sum of the number of times of charging of the battery 160 and the number of times of discharging of the battery 160. The cycle count of the battery 160 may be referred to as the number of times of charging/discharging.

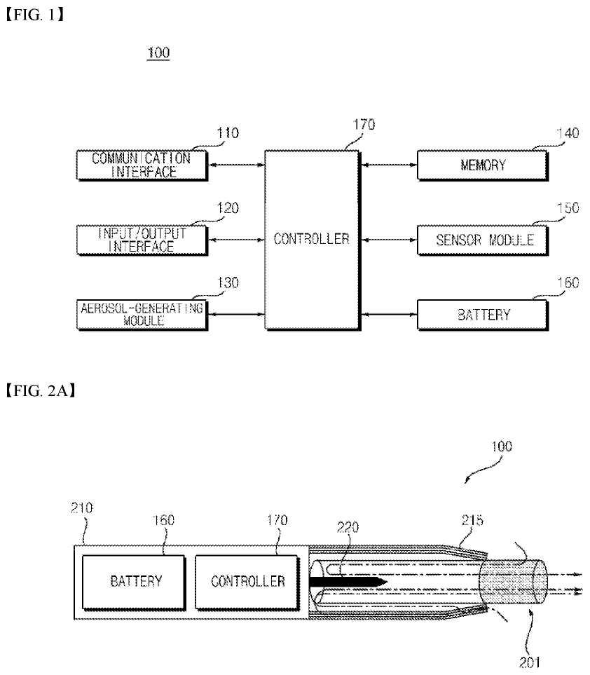

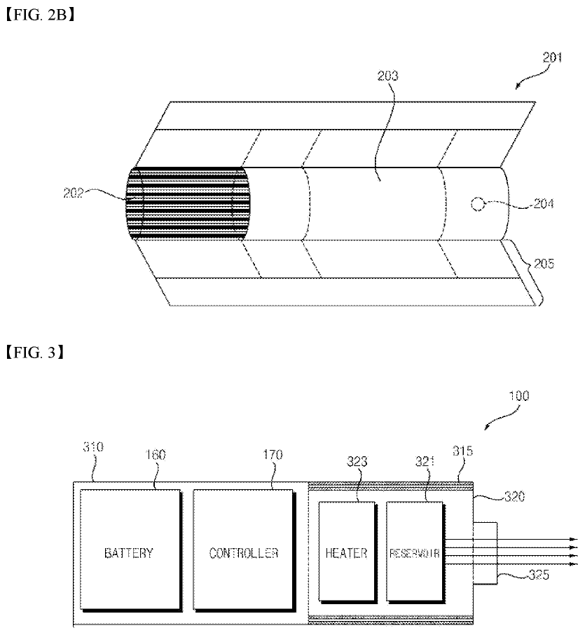

FIGS. 2A to 4 are views for explaining the aerosol-generating device according to embodiments of the present disclosure.

According to various embodiments of the present disclosure, the aerosol-generating device 100 may include a main body and/or a cartridge.

Referring to FIG. 2A, the aerosol-generating device 100 according to an embodiment may include a main body 210, which is formed such that a cigarette 201 can be inserted into the inner space formed by a housing 215.

The cigarette 201 may be similar to a general combustive cigarette. For example, the cigarette 201 may be divided into a first portion including an aerosol-generating substance and a second portion including a filter. Alternatively, the second portion of the cigarette 201 may also include an aerosol-generating substance. For example, a granular or capsular flavoring material may be inserted into the second portion.

The entirety of the first portion may be inserted into the aerosol-generating device 100. The second portion may be exposed to the outside. Alternatively, only a portion of the first portion may be inserted into the aerosol-generating device 100. Alternatively, the entirety of the first portion and a portion of the second portion may be inserted into the aerosol-generating device 100. The user may inhale the aerosol in the state of holding the second portion in the mouth. At this time, the aerosol may be generated as external air passes through the first portion. The generated aerosol may pass through the second portion to be introduced into the mouth of the user.

The main body 210 may be structured such that external air is introduced into the main body 210 in the state in which the cigarette 201 is inserted thereinto. In this case, the external air introduced into the main body 210 may flow into the mouth of the user via the cigarette 201.

When the cigarette 201 is inserted, the controller 170 may perform control such that electric power is supplied to the heater based on the temperature profile stored in the memory 140.

The controller 170 may perform control such that electric power is supplied to the heater using at least one of a pulse width modulation (PWM) method or a proportional-integral-differential (PID) method.

For example, the controller 170 may perform control such that a current pulse having a predetermined frequency and a predetermined duty ratio is supplied to the heater using the PWM method. In this case, the controller 170 may control the amount of electric power supplied to the heater by adjusting the frequency and the duty ratio of the current pulse.

For example, the controller 170 may determine a target temperature to be controlled based on the temperature profile. In this case, the controller 170 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

The heater may be disposed in the main body 210 at a position corresponding to the position at which the cigarette 201 is inserted into the main body 210. Although it is illustrated in the drawings that the heater is an electrically conductive heater 220 including a needle-shaped electrically conductive track, the present disclosure is not limited thereto.

The heater may heat the interior and/or exterior of the cigarette 201 using the electric power supplied from the battery 160. An aerosol may be generated from the heated cigarette 201. At this time, the user may hold one end of the cigarette 201 in the mouth to inhale the aerosol containing a tobacco material.

Meanwhile, the controller 170 may perform control such that electric power is supplied to the heater in the state in which the cigarette 201 is not inserted into the main body according to a predetermined condition. For example, when a cleaning function for cleaning the space into which the cigarette 201 is inserted is selected in response to a command input by the user through the input/output interface 120, the controller 170 may perform control such that a predetermined amount of electric power is supplied to the heater. The controller 170 may monitor the number of puffs based on the value sensed by the puff sensor from the time point at which the cigarette 201 was inserted into the main body.

When the cigarette 201 is removed from the main body, the controller 170 may initialize the current number of puffs stored in the memory 140.

Referring to FIG. 2B, the cigarette 201 according to an embodiment may include a tobacco rod 202 and a filter rod 203. The first portion described above with reference to FIG. 2A may include the tobacco rod 202. The second portion described above with reference to FIG. 2A may include the filter rod 203.

Although it is illustrated in FIG. 2B that the filter rod 203 is composed of a single segment, the present disclosure is not limited thereto. In other words, the filter rod 203 may be composed of a plurality of segments. For example, the filter rod 203 may include a first segment configured to cool an aerosol and a second segment configured to remove a predetermined component included in the aerosol. In addition, the filter rod 203 may further include at least one segment configured to perform other functions, as needed.

The cigarette 201 may be packed using at least one wrapper 205. The wrapper 205 may have at least one hole formed therein to allow external air to be introduced thereinto or to allow internal gas to be discharged therefrom. In one example, the cigarette 201 may be packed using one wrapper 205. In another example, the cigarette 201 may be doubly packed using two or more wrappers 205. For example, the tobacco rod 202 may be packed using a first wrapper. For example, the filter rod 203 may be packed using a second wrapper. The tobacco rod 202 and the filter rod 203, which are individually packed using separate wrappers, may be coupled to each other. The entire cigarette 201 may be packed using a third wrapper. When each of the tobacco rod 202 and the filter rod 203 is composed of a plurality of segments, each segment may be packed using a separate wrapper. The entire cigarette 201, formed by coupling segments, each of which is packed using a separate wrapper, to each other, may be packed using another wrapper.

The tobacco rod 202 may include an aerosol-generating substance. For example, the aerosol-generating substance may include at least one of glycerin, propylene glycol, ethylene glycol, dipropylene glycol, diethylene glycol, triethylene glycol, tetraethylene glycol, or oleyl alcohol, but the present disclosure is not limited thereto. Also, the tobacco rod 202 may include other additives, such as a flavoring agent, a wetting agent, and/or an organic acid. Also, a flavoring liquid, such as menthol or a moisturizer, may be injected into and added to the tobacco rod 202.

The tobacco rod 202 may be manufactured in various forms. For example, the tobacco rod 202 may be formed as a sheet or a strand. For example, the tobacco rod 202 may be formed as shredded tobacco, which is formed by cutting a tobacco sheet into tiny bits. For example, the tobacco rod 202 may be surrounded by a thermally conductive material. For example, the thermally conductive material may be a metal foil such as aluminum foil, but the present disclosure is not limited thereto. In one example, the thermally conductive material surrounding the tobacco rod 202 may uniformly distribute heat transmitted to the tobacco rod 202, thereby improving conduction of the heat applied to the tobacco rod. This may improve the taste of the tobacco. The thermally conductive material surrounding the tobacco rod 202 may function as a susceptor that is heated by the induction heater. Here, although not illustrated in the drawings, the tobacco rod 202 may further include an additional susceptor, in addition to the thermally conductive material surrounding the tobacco rod 202.

The filter rod 203 may be a cellulose acetate filter. The filter rod 203 may be formed in any of various shapes. For example, the filter rod 203 may be a cylinder-type rod. For example, the filter rod 203 may be a hollow tube-type rod. For example, the filter rod 203 may be a recess-type rod. When the filter rod 203 is composed of a plurality of segments, at least one of the plurality of segments may be formed in a different shape.

The filter rod 203 may be formed to generate flavors. In one example, a flavoring liquid may be injected into the filter rod 203. In one example, a separate fiber coated with a flavoring liquid may be inserted into the filter rod 203.

In addition, the filter rod 203 may include at least one capsule 204. Here, the capsule 204 may function to generate a flavor. The capsule 204 may function to generate an aerosol. For example, the capsule 204 may have a structure in which a liquid containing a flavoring material is wrapped with a film. The capsule 204 may have a spherical or cylindrical shape, but the present disclosure is not limited thereto.

When the filter rod 203 includes a segment configured to cool the aerosol, the cooling segment may be made of a polymer material or a biodegradable polymer material. For example, the cooling segment may be made of pure polylactic acid alone, but the present disclosure is not limited thereto. Alternatively, the cooling segment may be formed as a cellulose acetate filter having a plurality of holes formed therein. However, the cooling segment is not limited to the above-described example, and any other type of cooling segment may be used, so long as the same is capable of cooling the aerosol.

Although not illustrated in FIG. 2B, the cigarette 201 according to an embodiment may further include a front-end filter. The front-end filter may be located at the side of the tobacco rod 202 that faces the filter rod 203. The front-end filter may prevent the tobacco rod 202 from becoming detached outwards. The front-end filter may prevent a liquefied aerosol from flowing into the aerosol-generating device 100 from the tobacco rod 202 during inhalation by the user.

Referring to FIG. 3, the aerosol-generating device 100 according to an embodiment may include a main body 310 and a cartridge 320. The main body 310 may support the cartridge 320, and the cartridge 320 may contain an aerosol-generating substance.

According to one embodiment, the cartridge 320 may be configured so as to be detachably mounted to the main body 310. According to another embodiment, the cartridge 320 may be formed integrally with the main body 310. For example, the cartridge 320 may be mounted to the main body 310 in a manner such that at least a portion of the cartridge 320 is inserted into the inner space formed by a housing 315 of the main body 310.

The main body 310 may be formed to have a structure in which external air can be introduced into the main body 310 in the state in which the cartridge 320 is inserted thereinto. Here, the external air introduced into the main body 310 may flow into the user's mouth via the cartridge 320.

The controller 170 may determine whether the cartridge 320 is in a mounted state or a detached state using a cartridge detection sensor included in the sensor module 150. For example, the cartridge detection sensor may transmit a pulse current through a terminal connected to the cartridge 320. In this case, the cartridge detection sensor may determine whether the cartridge 320 is in a connected state, based on whether the pulse current is received through another terminal.

The cartridge 320 may include a reservoir 321 configured to contain the aerosol-generating substance and/or a heater 323 configured to heat the aerosol-generating substance in the reservoir 321. For example, a liquid delivery element impregnated with (containing) the aerosol-generating substance may be disposed inside the reservoir 321. The electrically conductive track of the heater 323 may be formed in a structure that is wound around the liquid delivery element. In this case, when the liquid delivery element is heated by the heater 323, an aerosol may be generated. Here, the liquid delivery element may include a wick made of, for example, cotton fiber, ceramic fiber, glass fiber, or porous ceramic.

The cartridge 320 may include a mouthpiece 325. Here, the mouthpiece 325 may be a portion to be inserted into a user's oral cavity. The mouthpiece 325 may have a discharge hole through which the aerosol is discharged to the outside during a puff.

Referring to FIG. 4, the aerosol-generating device 100 according to an embodiment may include a main body 410 supporting the cartridge 420 and a cartridge 420 containing an aerosol-generating substance. The main body 410 may be formed so as to allow a cigarette 401 to be inserted into an inner space 415 therein.

The aerosol-generating device 100 may include a first heater for heating the aerosol-generating substance stored in the cartridge 420. For example, when the user holds one end of the cigarette 401 in the mouth to inhale the aerosol, the aerosol generated by the first heater may pass through the cigarette 401. At this time, while the aerosol passes through the cigarette 401, a tobacco material may be added to the aerosol. The aerosol containing the tobacco material may be drawn into the user's oral cavity through one end of the cigarette 401.

Alternatively, according to another embodiment, the aerosol-generating device 100 may include a first heater for heating the aerosol-generating substance stored in the cartridge 420 and a second heater for heating the cigarette 401 inserted into the main body 410. For example, the aerosol-generating device 100 may generate an aerosol by heating the aerosol-generating substance stored in the cartridge 420 and the cigarette 401 using the first heater and the second heater, respectively.

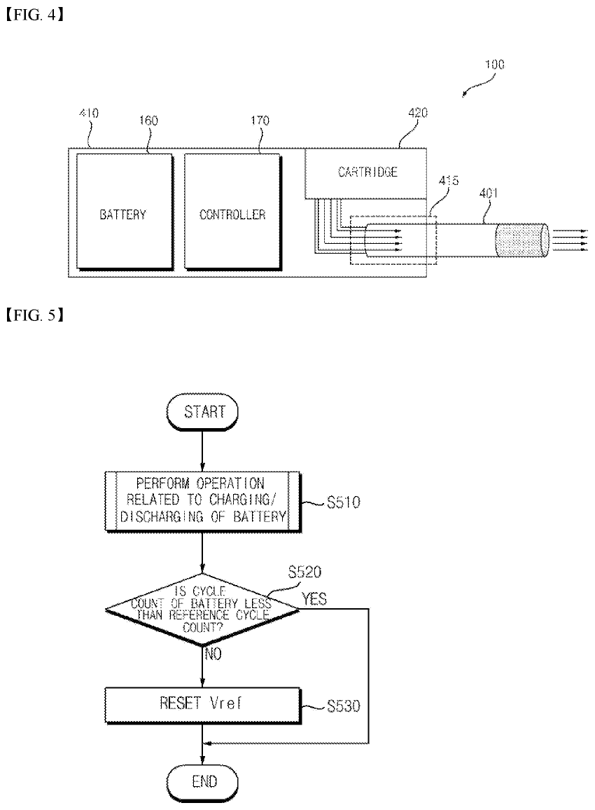

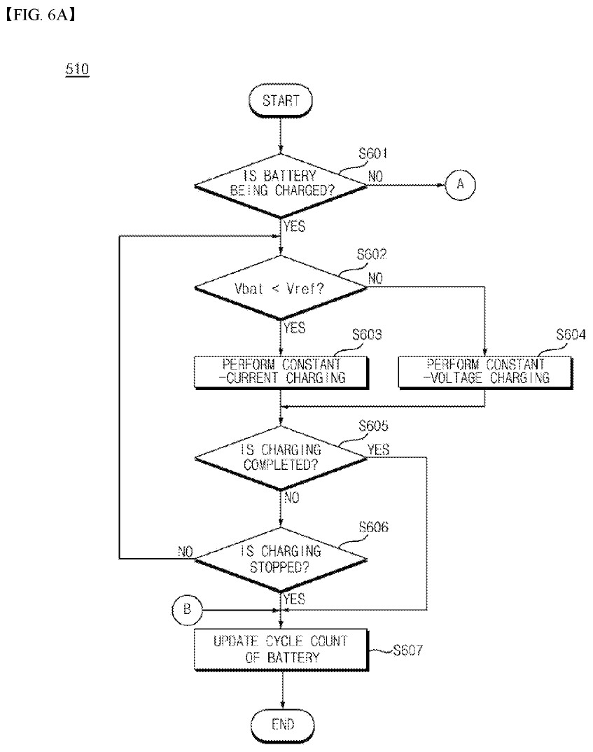

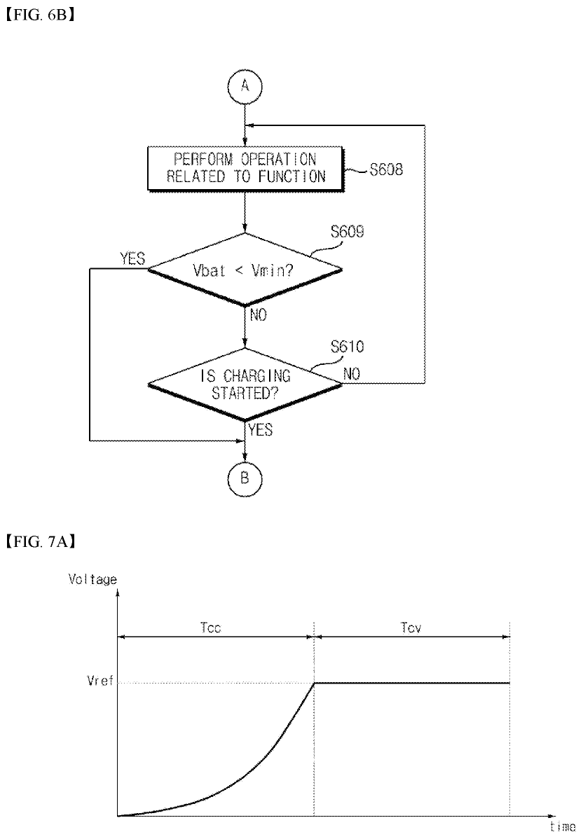

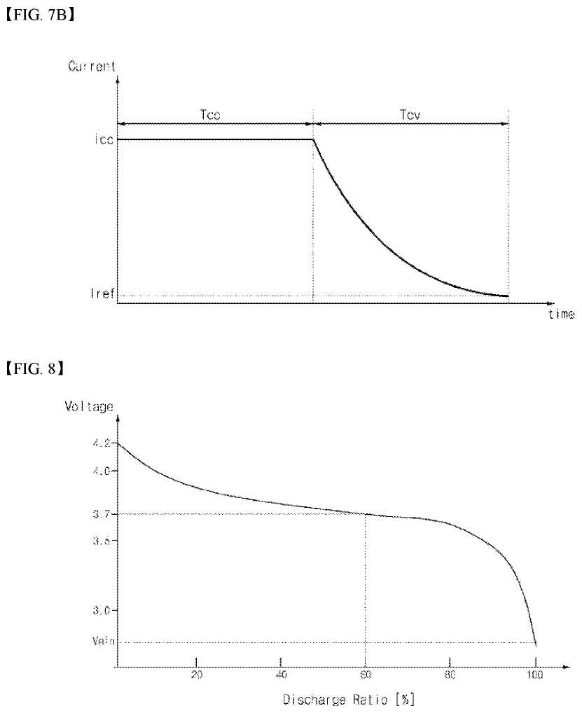

FIGS. 5 to 6B are flowcharts showing an operation method of the aerosol-generating device according to an embodiment of the present disclosure, and FIGS. 7A to 9 are views for explaining the operation of the aerosol-generating device.

Referring to FIG. 5, the aerosol-generating device 100 may perform operation related to charging/discharging of the battery 160 in operation S510. The aerosol-generating device 100 may update the cycle count of the battery 160 based on a result of performing operation related to charging/discharging of the battery 160. The charging/discharging of the battery 160 will be described with reference to FIGS. 6A and 6B.

Referring to FIG. 6A, the aerosol-generating device 100 may determine whether operation related to a charging function for charging the battery 160, among a plurality of functions, is being performed in operation S601. For example, the aerosol-generating device 100 may perform operation related to the charging function when electric power is supplied from the outside through a charging terminal formed at one side of the main body.

The aerosol-generating device 100 may check the voltage Vbat of the battery 160 when performing operation related to the charging function in operation S602. The aerosol-generating device 100 may determine whether the voltage Vbat of the battery 160 is less than a preset reference voltage Vref. For example, the aerosol-generating device 100 may monitor the voltage Vbat of the battery 160 by sensing the voltage applied to the battery 160 using a voltage sensor included in the sensor module 150 while charging the battery 160.

Here, the reference voltage Vref may be a voltage level preset to distinguish the charging stage of the battery 160. This will be described with reference to FIGS. 7A and 7B.

FIG. 7A is an example of a graph indicating the voltage of the battery 160, sensed while charging the battery 160, and FIG. 7B is an example of a graph indicating the current flowing through the battery 160, sensed while charging the battery 160. Referring to FIGS. 7A and 7B, the aerosol-generating device 100 may maintain the current flowing through the battery 160 at a preset first current level Icc in the section Tcc in which the voltage Vbat of the battery 160 is less than the reference voltage Vref. In this case, the voltage Vbat of the battery 160 may gradually increase.

Here, the section Tcc in which the current flowing through the battery 160 is maintained at the first current level Icc may be referred to as a “constant-current charging section”

Meanwhile, when the voltage Vbat of the battery 160 reaches the reference voltage Vref, the aerosol-generating device 100 may maintain the voltage Vbat of the battery 160 at the reference voltage Vref. In this case, the current flowing through the battery 160 may gradually decrease. The remaining capacity of the battery 160 may increase to the maximum capacity while the voltage Vbat of the battery 160 is maintained at the reference voltage Vref.

Here, the section Tev in which the voltage Vbat of the battery 160 is maintained at the reference voltage Vref may be referred to as a “constant-voltage charging section”

When the current flowing through the battery 160 reaches a second current level Iref, which is lower than the first current level Icc, in the constant-voltage charging section Tcv, the aerosol-generating device 100 may determine that the battery 160 has been fully charged.

Referring again to FIG. 6A, when the voltage Vbat of the battery 160 is less than the reference voltage Vref, the aerosol-generating device 100 may perform constant-current charging to maintain the current flowing through the battery 160 at a preset current level.

When the voltage Vbat of the battery 160 is equal to or greater than the reference voltage Vref, the aerosol-generating device 100 may perform constant-voltage charging to maintain the voltage Vbat of the battery 160 at the reference voltage Vref in operation S604. For example, when the voltage Vbat of the battery 160 reaches the reference voltage Vref, the aerosol-generating device 100 may perform constant-voltage charging.

The aerosol-generating device 100 may determine whether the battery 160 is fully charged, that is, whether charging of the battery 160 is completed, in operation S604. For example, when the current flowing through the battery 160 is equal to or less than a preset minimum current level, the aerosol-generating device 100 may determine that charging of the battery 160 has been completed.

When charging of the battery 160 is not completed, the aerosol-generating device 100 may determine whether charging of the battery 160 is stopped in operation S605. For example, the aerosol-generating device 100 may monitor whether the supply of electric power through the charging terminal is stopped. When the supply of electric power is stopped, the aerosol-generating device 100 may stop charging the battery 160.

When electric power is continuously supplied from the outside through the charging terminal in the state in which the battery 160 is not completely charged, the process proceeds to operation S602, so the aerosol-generating device 100 continuously performs operation related to the charging function.

On the other hand, when charging of the battery 160 is completed, or when charging of the battery 160 is stopped, the aerosol-generating device 100 may update the cycle count of the battery 160 in operation S607.

The aerosol-generating device 100 may calculate a difference between the remaining capacity of the battery 160 measured at the time of completion of charging of the battery 160 or the time of stop of charging of the battery 160 and the remaining capacity of the battery 160 measured at the time of start of the operation related to the charging function. For example, when the remaining capacity of the battery 160 measured at the time of completion of charging of the battery 160 is 100% and when the remaining capacity of the battery 160 measured at the time of start of the operation related to the charging function is 30%, the difference between the two remaining capacities may be calculated to be 70%. For example, when the remaining capacity of the battery 160 measured at the time of stop of charging of the battery 160 is 85% and when the remaining capacity of the battery 160 measured at the time of start of the operation related to the charging function is 45%, the difference between the two remaining capacities may be calculated to be 40%.

The aerosol-generating device 100 may sum the remaining capacity included in data regarding charging, which is stored in the memory 140, and the calculated difference between the remaining capacities. The aerosol-generating device 100 may determine whether a result of summing the remaining capacities is equal to or greater than a preset reference capacity (e.g. 100%). Here, the remaining capacity included in the data regarding charging may be referred to as a “previous remaining capacity.”

In this case, when the result of summing the remaining capacities is equal to or greater than the reference capacity (e.g. 100%), the aerosol-generating device 100 may increase the number of times of charging of the battery 160, stored in the memory 140, by one.

In addition, the aerosol-generating device 100 may update the remaining capacity included in the data regarding charging, stored in the memory 140, with a remaining capacity corresponding to the difference between the result of summing the remaining capacities and the reference capacity (e.g. 100%).

On the other hand, when the result of summing the remaining capacities is less than the reference capacity (e.g. 100%), the aerosol-generating device 100 may update the remaining capacity included in the data regarding charging, stored in the memory 140, with the result of summing the remaining capacities.

Referring to FIG. 6B, the aerosol-generating device 100 may perform operation related to any one of the functions other than the charging function, among the plurality of functions, in operation S608. For example, when electric power is not supplied from the outside through the charging terminal formed at one side of the main body, the aerosol-generating device 100 may supply electric power stored in the battery 160 to the heater to perform operations related to a preheating function, a heating function, and a cleaning function.

The aerosol-generating device 100 may check the voltage Vbat of the battery 160 in operation S609. The aerosol-generating device 100 may determine whether the voltage Vbat of the battery 160 is less than a preset minimum voltage Vmin.

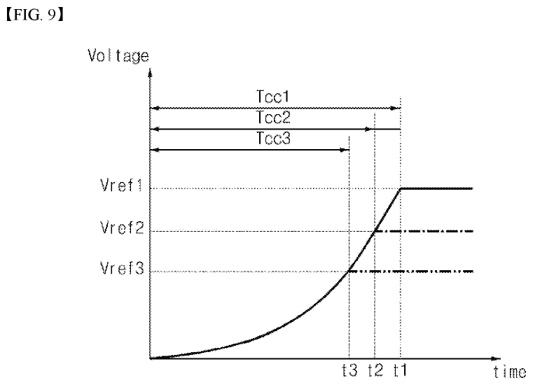

Here, the minimum voltage Vmin may be the lowest level of the output voltage of the battery 160 at which the aerosol-generating device 100 is capable of performing a predetermined function. This will be described with reference to FIG. 8.

FIG. 8 is an example of a graph indicating the output voltage of the battery 160, sensed while the battery 160 is discharged.

Referring to FIG. 8, while the aerosol-generating device 100 performs a predetermined function, the battery 160 may be discharged. As the battery 160 is discharged, the output voltage of the battery 160 may gradually decrease.

For example, when the degree to which the battery 160 is discharged (hereinafter referred to as an “amount of discharge”) is 0%, that is, when the battery 160 is in a fully charged state, the output voltage of the battery 160 may be sensed to be 4.2V. When the amount of discharge of the battery 160 is 60%, the output voltage of the battery 160 may be sensed to be 3.7V. In this case, the amount of discharge of the battery 160 may correspond to a value obtained by subtracting the current remaining capacity from the maximum remaining capacity of the battery 160 (e.g. 100%).

Referring again to FIG. 6B, when the voltage Vbat of the battery 160 is equal to or greater than the minimum voltage Vmin, the aerosol-generating device 100 may determine whether the charging function is started in operation S610. For example, when electric power is supplied from the outside through the charging terminal, the aerosol-generating device 100 may determine that the operation related to the charging function is started.

When the voltage Vbat of the battery 160 is equal to or greater than the minimum voltage Vmin and when the charging function is not started, the process proceeds to operation S608, so the aerosol-generating device 100 continuously performs operation related to any one of the functions other than the charging function.

On the other hand, when the voltage Vbat of the battery 160 is less than the minimum voltage Vmin, or when the operation related to the charging function is started, the process proceeds to operation S607, so the aerosol-generating device 100 updates the cycle count of the battery 160.

The aerosol-generating device 100 may calculate a difference between the remaining capacity of the battery 160 measured when the voltage Vbat of the battery 160 is less than the minimum voltage Vmin or when the operation related to the charging function is started and the remaining capacity measured when discharging of the battery 160 is started. That is, the aerosol-generating device 100 may calculate a difference in the amount of discharge between the two time points. For example, when the amount of discharge measured when the voltage Vbat of the battery 160 is less than the minimum voltage Vmin, that is, when the battery 160 is completely discharged, is 100% and when the amount of discharge measured when discharging of the battery 160 is started is 20%, the difference between the amounts of discharge may be calculated to be 80%. For example, when the amount of discharge measured when the operation related to the charging function is started is 85% and when the amount of discharge measured when discharging of the batter 160 is started is 55%, the difference between the amounts of discharge may be calculated to be 30%.

The aerosol-generating device 100 may sum the amount of discharge included in the data regarding discharging, which is stored in the memory 140, and the calculated difference between the amounts of discharge. The aerosol-generating device 100 may determine whether the result of summing the amounts of discharge is equal to or greater than a preset reference amount of discharge (e.g. 100%). Here, the amount of discharge included in the data regarding discharging may be referred to as a “previous amount of discharge”

In this case, when the result of summing the amounts of discharge is equal to or greater than the reference amount of discharge (e.g. 100%), the aerosol-generating device 100 may increase the number of times of discharging of the battery 160, stored in the memory 140, by one. In addition, the aerosol-generating device 100 may update the amount of discharge included in the data regarding discharging, stored in the memory 140, with the amount of discharge corresponding to the difference between the result of summing the amounts of discharge and the reference amount of discharge (e.g. 100%).

On the other hand, when the result of summing the amounts of discharge is less than the reference amount of discharge (e.g. 100%), the aerosol-generating device 100 may update the amount of discharge included in the data regarding discharge, stored in the memory 140, with the result of summing the amounts of discharge.

Referring again to FIG. 5, the aerosol-generating device 100 may determine whether the cycle count of the battery 160 is less than a preset reference cycle count in operation S520. Here, the reference cycle count may be determined in consideration of the possibility of the occurrence of swelling of the battery 160 attributable to deterioration thereof due to repeated charging/discharging.

When the cycle count of the battery 160 is equal to or greater than a preset reference cycle count (e.g. 500), the aerosol-generating device 100 may reset the reference voltage Vref used when charging the battery in operation S530. That is, when the cycle count of the battery 160 is equal to or greater than the reference cycle count (e.g. 500), the aerosol-generating device 100 may determine that the battery 160 has been deteriorated to a certain level or more, and may reset the reference voltage Vref used when charging the battery.

The aerosol-generating device 100 may change the reference voltage Vref used when charging the battery to a second voltage, which is lower than the currently set first voltage. In this case, the aerosol-generating device 100 may determine the second voltage based on the currently set first voltage using a preset ratio. Here, the preset ratio may be a ratio of a difference between the currently set first voltage and the second voltage to the first voltage. For example, when the currently set first voltage is 4.40V and when the preset ratio is 7%, the aerosol-generating device 100 may determine the second voltage to be 4.09V.

FIG. 9 is an example of a graph indicating the voltage of the battery 160, sensed while the battery 160 is charged, in the case of resetting the reference voltage Vref.

Referring to FIG. 9, as the cycle count of the battery 160 increases, the aerosol-generating device 100 may reset the reference voltage Vref such that the reference voltage Vref is gradually lowered from a first voltage Vref1 to a third voltage Vref3.

In this case, as the cycle count of the battery 160 increases, the time taken for the voltage Vbat of the battery 160 to reach the reference voltage Vref when charging the battery may be gradually shortened from a time t1 to a time t3. Further, as the cycle count of the battery 160 increases, the constant-current charging section in which the current flowing through the battery 160 is maintained constant may also be shortened.

The ratio preset for resetting the reference voltage Vref may be changed according to the number of resets of the reference voltage Vref.

TABLE 1

| Number of Resets | Ratio |
|---|---|
| 0 | 10% |
| 1 | 7% |
| 2 | 5% |
| 3 | 3% |
| 4 or more | 1% |

For example, the aerosol-generating device 100 may reset the reference voltage Vref based on the ratio that decreases as the number of resets of the reference voltage Vref increases, as shown in Table 1 above. Accordingly, it is possible to prevent the reference voltage Vref from being excessively lowered when charging the battery. Also, when the reference voltage Vref is reset, the aerosol-generating device 100 may initialize the cycle count of the battery 160.

On the other hand, when the voltage Vbat of the battery 160 is less than the minimum voltage Vmin, the aerosol-generating device 100 may update the cycle count of the battery 160 and/or the reference voltage Vref, and may turn off the power.

As described above, according to at least one of the embodiments of the present disclosure, the reference voltage Vref used when charging the battery is reset based on the cycle count of the battery according to charging and/or discharging of the battery 160, thus making it possible to prevent the occurrence of swelling of the battery 160 attributable to deterioration or overcharging thereof.

Referring to FIGS. 1 to 9, an aerosol-generating device 100 according to an embodiment of the present disclosure may include a heater configured to heat an aerosol-generating substance, a battery 160 configured to supply electric power to the heater, and a controller 170. The controller 170 may update the number of times of charging/discharging of the battery 160 based on at least one of a result of performing operation related to charging or a result of performing operation related to discharging. When the number of times of charging/discharging of the battery 160 is less than a preset reference number of times, the controller 170 may maintain a reference voltage preset in relation to charging of the battery 160. When the number of times of charging/discharging of the battery 160 is equal to or greater than the preset reference number of times, the controller 170 may change the reference voltage to a second voltage level, which is lower than the currently set first voltage level.

In addition, in accordance with another aspect of the present disclosure, when the voltage of the battery 160 is less than the reference voltage when charging the battery 160, the controller 170 may perform control such that the current flowing through the battery 160 is maintained at a predetermined current level. When the voltage of the battery 160 is equal to or greater than the reference voltage when charging the battery 160, the controller 170 may perform control such that the voltage of the battery 160 is maintained at the reference voltage.

In addition, in accordance with another aspect of the present disclosure, the aerosol-generating device 100 may further include a memory 140 configured to store therein at least one of data regarding charging or data regarding discharging. The controller 170 may update the number of times of charging/discharging of the battery 160 based on data stored in the memory 140.

In addition, in accordance with another aspect of the present disclosure, the controller 170 may calculate a difference between the remaining capacity of the battery 160 measured at a time of start of the operation related to charging and the remaining capacity of the battery 160 measured at a time of end of the operation related to charging. When a result of summing the calculated difference and a previous remaining capacity is equal to or greater than a preset reference capacity, the controller 170 may update the number of times of charging/discharging of the battery 160. When the result of summing is less than the preset reference capacity, the controller 170 may maintain the number of times of charging/discharging of the battery 160.

In addition, in accordance with another aspect of the present disclosure, the controller 170 may calculate a difference between the remaining capacity of the battery 160 measured at a time of start of the operation related to charging and the remaining capacity of the battery 160 measured at a time of end of the operation related to charging. When a result of summing the calculated difference and a previous remaining capacity is equal to or greater than a preset reference capacity, the controller 170 may change the previous remaining capacity to a remaining capacity corresponding to a difference between the result of summing and the preset reference capacity. When the result of summing is less than the preset reference capacity, the controller 170 may change the previous remaining capacity to the result of summing.

In addition, in accordance with another aspect of the present disclosure, the controller 170 may calculate a difference between the amount of discharging of the battery 160 measured at a time of start of the operation related to discharging and the amount of discharging of the battery 160 measured at a time of end of the operation related to discharging. When a result of summing the calculated difference and a previous amount of discharging is equal to or greater than a preset reference amount of discharging, the controller 170 may update the number of times of charging/discharging of the battery 160. When the result of summing is less than the preset reference amount of discharging, the controller 170) may maintain the number of times of charging/discharging of the battery 160.

In addition, in accordance with another aspect of the present disclosure, the controller 170 may calculate a difference between the amount of discharging of the battery 160 measured at a time of start of the operation related to discharging and the amount of discharging of the battery 160 measured at a time of end of the operation related to discharging. When a result of summing the calculated difference and a previous amount of discharging is equal to or greater than a preset reference amount of discharging, the controller 170 may change the previous amount of discharging to an amount of discharging corresponding to a difference between the result of summing and the preset reference amount of discharging. When the result of summing is less than the preset reference amount of discharging, the controller 170 may change an amount of discharging included in the data regarding discharging to the result of summing.

In addition, in accordance with another aspect of the present disclosure, the ratio of a difference between the first voltage level and the second voltage level to the first voltage level may decrease as the number of changes of the reference voltage increases.

In addition, an operation method of the aerosol-generating device 100 according to an embodiment of the present disclosure may include updating the number of times of charging/discharging of a battery 160 of the aerosol-generating device based on at least one of a result of performing operation related to charging or a result of performing operation related to discharging, maintaining, when the number of times of charging/discharging of the battery 160 is less than a preset reference number of times, a reference voltage preset in relation to charging of the battery 160, and changing, when the number of times of charging/discharging of the battery 160 is equal to or greater than the preset reference number of times, the reference voltage to a second voltage level, which is lower than the currently set first voltage level.

In addition, in accordance with another aspect of the present disclosure, the operation method of the aerosol-generating device 100 may further include maintaining, when the voltage of the battery 160 is less than the reference voltage when charging the battery 160, the current flowing through the battery 160 at a predetermined current level and maintaining, when the voltage of the battery 160 is equal to or greater than the reference voltage when charging the battery 160, the voltage of the battery 160 at the reference voltage.

In addition, in accordance with another aspect of the present disclosure, the updating the number of times of charging/discharging of the battery 160 may be performed based on at least one of data regarding charging or data regarding discharging, stored in a memory 140 of the aerosol-generating device.

In addition, in accordance with another aspect of the present disclosure, the updating the number of times of charging/discharging of the battery 160 may include calculating a difference between the remaining capacity of the battery 160 measured at a time of start of the operation related to charging and the remaining capacity of the battery 160 measured at a time of end of the operation related to charging, updating, when a result of summing the calculated difference and a previous remaining capacity is equal to or greater than a preset reference capacity, the number of times of charging/discharging of the battery 160, and maintaining, when the result of summing is less than the preset reference capacity, the number of times of charging/discharging of the battery 160.

In addition, in accordance with another aspect of the present disclosure, the updating the number of times of charging/discharging of the battery 160 may include calculating a difference between the remaining capacity of the battery 160 measured at a time of start of the operation related to charging and the remaining capacity of the battery 160 measured at a time of end of the operation related to charging, changing, when a result of summing the calculated difference and a previous remaining capacity is equal to or greater than a preset reference capacity, the previous remaining capacity to a remaining capacity corresponding to a difference between the result of summing and the preset reference capacity, and changing, when the result of summing is less than the preset reference capacity, the previous remaining capacity to the result of summing.

In addition, in accordance with another aspect of the present disclosure, the updating the number of times of charging/discharging of the battery 160 may include calculating a difference between the amount of discharging of the battery 160 measured at a time of start of the operation related to discharging and the amount of discharging of the battery 160 measured at a time of end of the operation related to discharging, updating, when a result of summing the calculated difference and a previous amount of discharging is equal to or greater than a preset reference amount of discharging, the number of times of charging/discharging of the battery 160, and maintaining, when the result of summing is less than the preset reference amount of discharging, the number of times of charging/discharging of the battery 160.

In addition, in accordance with another aspect of the present disclosure, the updating the number of times of charging/discharging of the battery 160 may include calculating a difference between the amount of discharging of the battery 160 measured at a time of start of the operation related to discharging and the amount of discharging of the battery 160 measured at a time of end of the operation related to discharging, changing, when a result of summing the calculated difference and a previous amount of discharging is equal to or greater than a preset reference amount of discharging, the previous amount of discharging to an amount of discharging corresponding to a difference between the result of summing and the preset reference amount of discharging, and changing, when the result of summing is less than the preset reference amount of discharging, the previous amount of discharging to the result of summing.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a heater configured to heat an aerosol-generating substance:
a battery configured to supply electric power to the heater; and
a controller configured to:
update a number of times of charging/discharging of the battery based on at least a result of performing an operation related to charging or a result of performing an operation related to discharging, and
based on the number of times of charging/discharging being less than a preset reference number, maintain a reference voltage preset in relation to charging of the battery, and
based on the number of times of charging/discharging being greater than or equal to the preset reference number, change the reference voltage preset in relation to charging of the battery to a second voltage level which is lower than a currently set first voltage level.

2. The aerosol-generating device according to claim 1, wherein the controller is configured to:
based on a voltage of the battery being less than the reference voltage when charging the battery, perform control to charge the battery such that a current flowing through the battery is maintained at a predetermined current level, and
based on the voltage of the battery being greater than or equal to the reference voltage when charging the battery, perform control to charge the battery such that the voltage of the battery is maintained at the reference voltage.

3. The aerosol-generating device according to claim 1, wherein a ratio of a difference between the first voltage level and the second voltage level to the first voltage level decreases as a number of changes of the reference voltage increases.

4. The aerosol-generating device according to claim 1, further comprising:
a memory configured to store at least one of data regarding charging or data regarding discharging,
wherein the controller is configured to update the number of times of charging or discharging based on data stored in the memory.

5. The aerosol-generating device according to claim 1, wherein the controller is configured to:
calculate a difference between a remaining capacity of the battery measured at a start time of the operation related to charging and a remaining capacity of the battery measured at an end time of the operation related to charging,
based on a sum of the calculated difference and a previous remaining capacity being greater than or equal to a preset reference capacity, update the number of times of charging/discharging, and
based on the sum being less than the preset reference capacity, maintain the number of times of charging/discharging.

6. The aerosol-generating device according to claim 1, wherein the controller is configured to:
calculate a difference between a remaining capacity of the battery measured at a start time of the operation related to charging and a remaining capacity of the battery measured at an end time of the operation related to charging,
based on a sum of the calculated difference and a previous remaining capacity being greater than or equal to a preset reference capacity, change the previous remaining capacity to a difference between the sum and the preset reference capacity, and
based on the sum being less than the preset reference capacity, change the previous remaining capacity to the sum.

7. The aerosol-generating device according to claim 1, wherein the controller is configured to:
calculate a difference between a discharged amount of the battery measured at a start time of the operation related to discharging and a discharged amount of the battery measured at an end time of the operation related to discharging,
based on a sum of the calculated difference and a previous discharged amount being greater than or equal to a preset reference discharged amount, update the number of times of charging/discharging, and
based on the sum being less than the preset reference discharged amount, maintain the number of times of charging/discharging.

8. The aerosol-generating device according to claim 1, wherein the controller is configured to:
calculate a difference between a discharged amount of the battery measured at a start time of the operation related to discharging and a discharged amount of the battery measured at an end time of the operation related to discharging,
based on a sum of the calculated difference and a previous discharged amount being greater than or equal to a preset reference discharged amount, change the previous discharged amount to a difference between the sum and the preset reference discharged amount, and
based on the sum being less than the preset reference discharged amount, change the previous discharged amount to the sum.

9. An operation method of an aerosol-generating device, the method comprising:
updating a number of times of charging/discharging of a battery of the aerosol-generating device based on at least a result of performing an operation related to charging or a result of performing an operation related to discharging:
maintaining a reference voltage preset in relation to charging of the battery based on the number of times of charging/discharging being less than a preset reference number; and
changing the reference voltage preset in relation to charging of the battery to a second voltage level which is lower than a currently set first voltage level based on the number of times of charging/discharging being greater than or equal to the preset reference number.

10. The method according to claim 9, further comprising:
charging the battery such that a current flowing through the battery is maintained at a predetermined current level based on a voltage of the battery being less than the reference voltage; and
charging the battery such that the voltage of the battery is maintained at the reference voltage based on the voltage of the battery being greater than or equal to the reference voltage.

11. The method according to claim 9, wherein the updating the number of times of charging/discharging is performed based on at least one of data regarding charging or data regarding discharging stored in a memory of the aerosol-generating device.

12. The method according to claim 9, wherein the updating the number of times of charging/discharging comprises:
calculating a difference between a remaining capacity of the battery measured at a start time of the operation related to charging and a remaining capacity of the battery measured at an end time of the operation related to charging:
based on a sum of the calculated difference and a previous remaining capacity being greater than or equal to a preset reference capacity, updating the number of times of charging/discharging; and
based on the sum being less than the preset reference capacity, maintaining the number of times of charging/discharging.

13. The method according to claim 9, wherein the updating the number of times of charging/discharging comprises:
calculating a difference between a remaining capacity of the battery measured at a start time of the operation related to charging and a remaining capacity of the battery measured at an end time of the operation related to charging:
based on a sum of the calculated difference and a previous remaining capacity being greater than or equal to a preset reference capacity, changing the previous remaining capacity to a difference between the sum and the preset reference capacity; and
based on the sum being less than the preset reference capacity, changing the previous remaining capacity to the sum.

14. The method according to claim 9, wherein the updating the number of times of charging/discharging comprises:
calculating a difference between discharged amount of the battery measured at a start time of the operation related to discharging and discharged amount of the battery measured at an end time of the operation related to discharging:
based on a sum of the calculated difference and a previous discharged amount being greater than or equal to a preset reference discharged amount, updating the number of times of charging/discharging; and
based on the sum being less than the preset reference discharged amount, maintaining the number of times of charging/discharging.

15. The method according to claim 9, wherein the updating the number of times of charging/discharging comprises:
calculating a difference between a discharged amount of the battery measured at a start time of the operation related to discharging and a discharged amount of the battery measured at an end time of the operation related to discharging;
based on a sum of the calculated difference and a previous discharged amount being greater than or equal to a preset reference discharged amount, changing the previous discharged amount to a difference between the sum and the preset reference discharged amount; and
based on the sum being less than the preset reference discharged amount, changing the previous discharged amount to the sum.
